(19) United States
(12) Patent Application Publication
(10) Pub. No.: US 2025/0289388 A1
(43) Pub. Date: Sep. 18, 2025

(54) Grille and Screen Mounting Assembly

(71) Applicant: Grand Aces Enterprise LLC dba Steel Bison USA, Prosper, TX (US)

(72) Inventor: Chin-Yu Anthony Liu, Prosper, TX (US)

(21) Appl. No.: 19/061,804

(22) Filed: Feb. 24, 2025

Related U.S. Application Data
(60) Provisional application No. 63/557,168, filed on Feb. 23, 2024.

(51) Int. Cl. B60R 19/52; B60R 13/00

(52) U.S. Cl. CPC B60R 19/52; B60R 13/005; B60R 2019/525

(57) ABSTRACT

An apparatus for a front grille assembly for motor vehicles, and a method of installing such includes providing a front grille frame, a screen, a grille plate, and a series of fastener apertures and features. The grille frame may be installed onto the hood of a motor vehicle by a mounting geometry matching the geometry of the hood, and fasteners matching the fasteners of the hood. The screen and grille plate may be installed onto the grille frame by a series of fasteners, such that the screen and grille plate may be removed and replaced without needing access to the interior surface of the hood.

### CROSS REFERENCE TO RELATED APPLICATION

This application is a non-provisional application claiming priority from U.S. Provisional Application Ser. No. 63/557,168, filed Feb. 23, 2024, and incorporated herein by reference in its entirety.

### TECHNICAL FIELD

This disclosure generally relates to an assembly for mounting a front grille and screen to a vehicle hood. In particular aspects, the disclosure relates to a front grille and screen assembly that is configured to removably mount to the hood of a vehicle and allow for ease of access and ease of removal, installation, and replacement of a debris-catching screen, and for interchangeability of a decorative front.

### BACKGROUND

Motor vehicles, such as trucks, often include a front grille covering an opening in a front hood assembly of the motor vehicle. The opening in the front hood assembly allows air to enter and flow past one or more heat exchangers (e.g., a radiator) of the motor vehicle for cooling purposes. The front grille typically covers the opening to protect the engine and other components located under or behind the hood, while still allowing air to enter the front of the hood.

An example front grille assembly, in accordance with the present disclosure, may include a grille frame with fins or some grate pattern to make the grille aerodynamic and in some cases add aesthetic qualities. The grille frame may also comprise fastener apertures or some suitable mechanical method of mounting the grille frame to the front hood. In addition to the grille frame, the front grille assembly may also include a screen to help prevent debris, such as dirt or insects, from entering through the hood of the vehicle and damaging the automotive components by first filtering the air before it enters the hood. In some examples, the screen may also include aerodynamic features to help regulate and/or direct airflow into the engine or motor of the vehicle and, thus, regulate the cooling of the engine and other components.

### BRIEF DESCRIPTION OF THE DRAWINGS

FIG. 1 illustrates an overall perspective view of an example front grille assembly for a motor vehicle.

FIG. 2 illustrates a front perspective view of a grille frame of the example front grille assembly of FIG. 1.

FIG. 3 illustrates a rear perspective view of the grille frame of the example front grille assembly of FIG. 1.

FIG. 4 illustrates a detail view of a threaded nut insert of the grille frame of FIG. 2.

FIG. 5 illustrates a detail view of a damper pad of the grille frame of FIG. 2.

FIG. 6 illustrates a front perspective view of a screen of the example front grille assembly of FIG. 1.

FIG. 7 illustrates a detail view of the screen of FIG. 6.

FIG. 8 illustrates a front perspective view of the grille of the example front grille assembly of FIG. 1.

FIG. 9 illustrates a front perspective view of the screen and grille frame of the example front grille assembly of FIG. 1.

FIG. 10 illustrates a detail view of bolt fasteners and washers of the example front grille assembly of FIG. 1.

FIG. 11 illustrates a front perspective view of a screen and grille frame of the example front grille assembly of FIG. 1 as attached to an example truck.

FIG. 12 illustrates a front perspective view of the example front grille assembly.

FIG. 13 illustrates a front perspective view of the example front grille assembly.

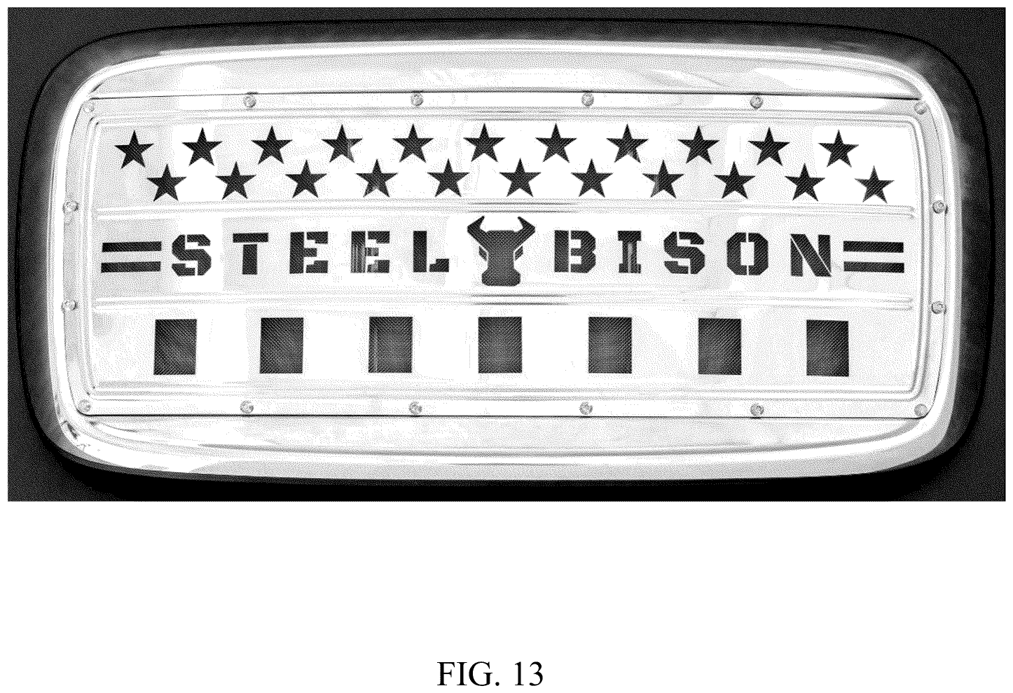

FIG. 14 illustrates a front perspective view of the example front grille assembly.

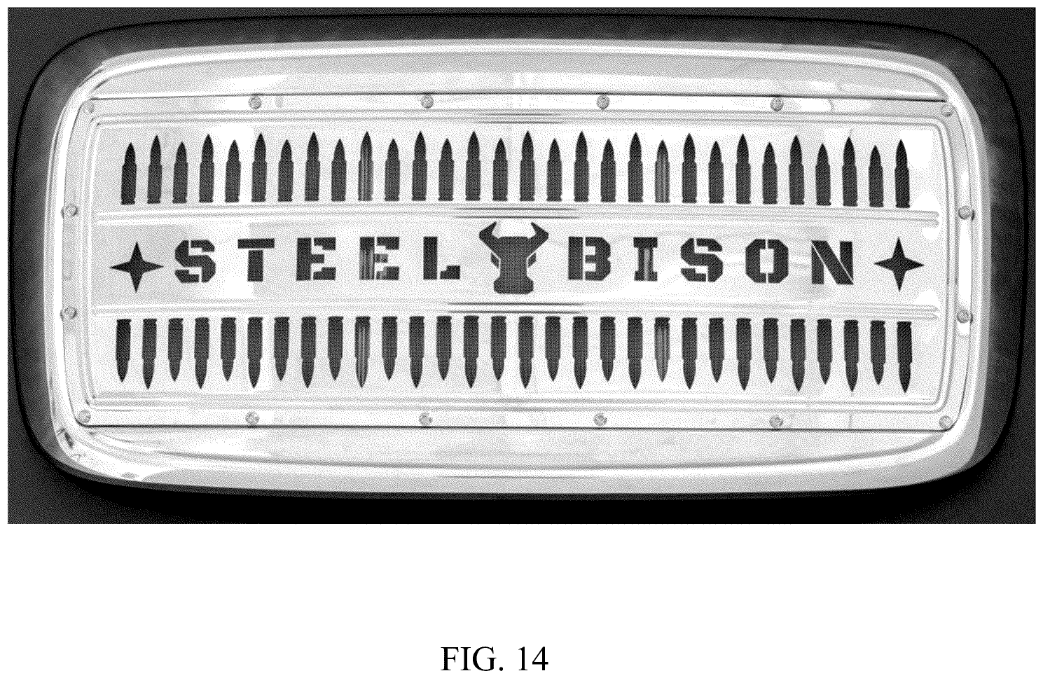

FIG. 15 illustrates a front perspective view of the example front grille assembly.

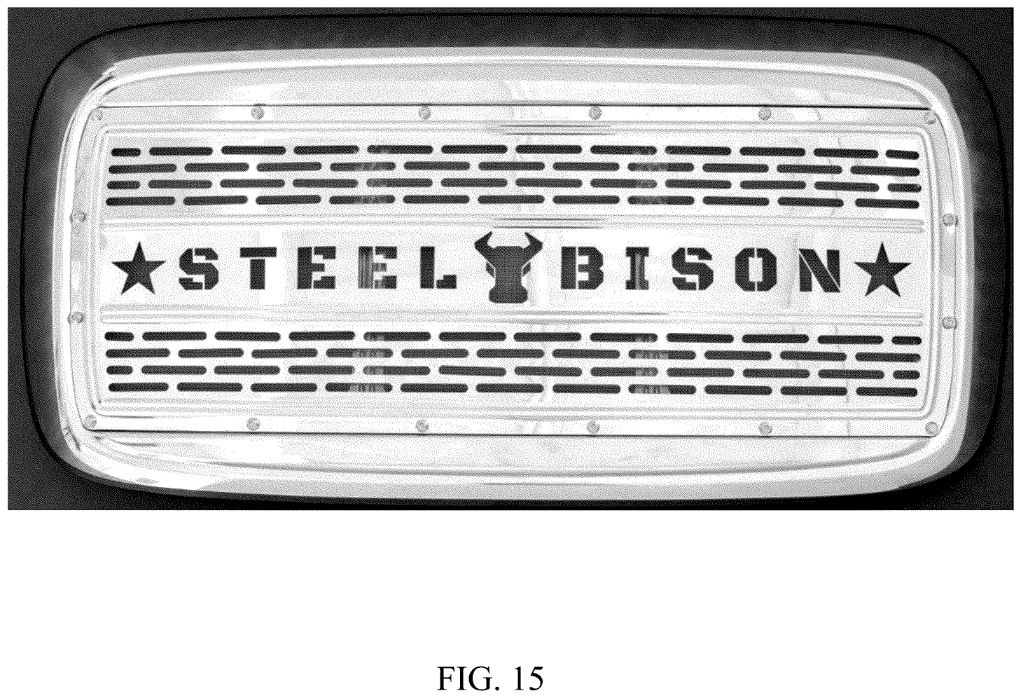

FIG. 16 illustrates a front perspective view of the example front grille assembly.

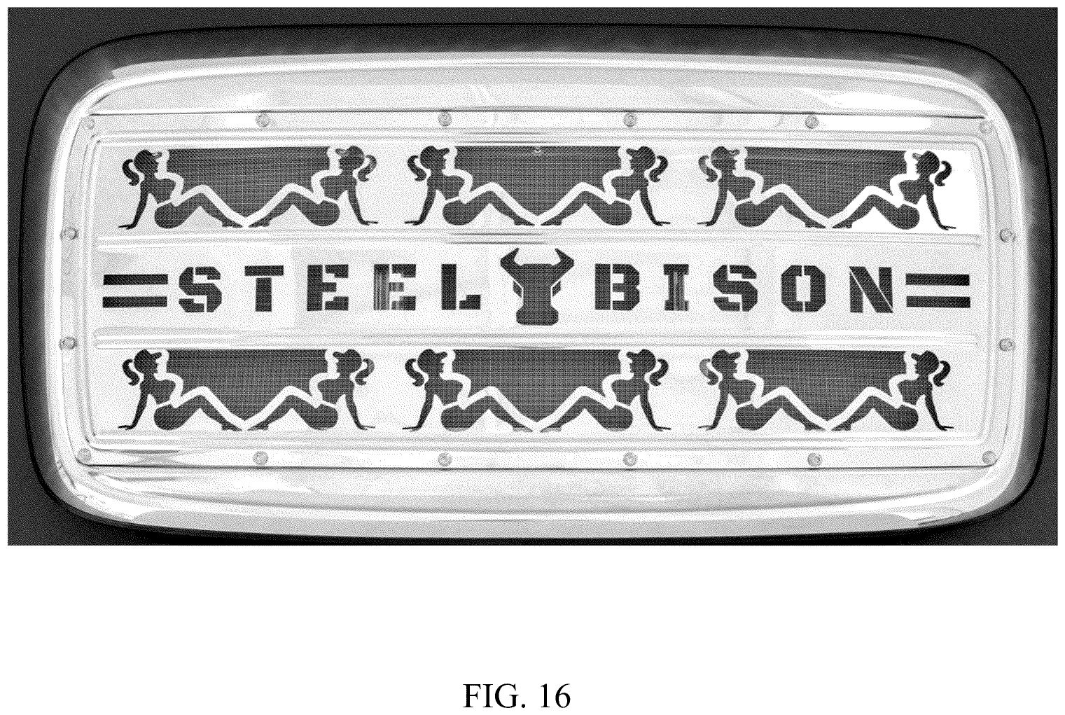

FIG. 17 illustrates a front perspective view of the screen and grille frame of the example front grille assembly of FIG. 1.

FIG. 18 illustrates a front perspective view of the screen and grille frame of the example front grille assembly of FIG. 1.

### DETAILED DESCRIPTION

Traditionally, a front grille assembly is typically installed on a motor vehicle front hood. For instance, a known front grille assembly typically includes a grille frame, which further contains fins or a grate pattern to make the grille frame aerodynamic or aesthetically pleasing. The front grille assembly may also contain a screen mounted to the grille frame. The screen may filter the air entering through the front hood of the vehicle to remove bugs, small stones, dirt, and other roadway debris. The screen may also serve to regulate air flow into the front hood and over the engine and other automotive components, and thus regulate the rate of cooling of those components. The screen may typically be mounted to the grille frame by a plurality of clips, which attach to retention features on the grille frame.

The clips secure the screen from the back of the grille frame (inside the hood and in the engine compartment of the vehicle) by wedging the screen between a flat surface on the clip, and a surface on the grille frame. The clip is retained to the grille frame by interlocking tabs on the clip with tabs on the grille frame.

In some motor vehicles, such as trucks, the screen of the front grille assembly may occasionally need replacing. In current front grille assemblies, the screen may only be replaced by removing the entire front grille, and/or raising the front hood to access the internal engine compartment or back of the grille frame and removing the screen from the back of the grille. The screen may only be removed by breaking and cutting away the clips used to secure the screen to the grille frame.

Consequently, an example front grille assembly as disclosed herein may be provided to reduce the effort and time needed to clean and/or replace the screen in the front grille assembly, and to provide a modular system by which the aesthetic and aerodynamic features of the front grille assembly may be easily removed, replaced, or changed. The example grille frame may have a form factor to mount the frame to existing front hood designs of existing vehicles. The grille frame may further comprise mechanical mounting features to mount the grille frame to an existing vehicle hood. The grille frame may also have mechanical mounting features to fasten a removable, replaceable screen to the grille frame. The grille frame also may have mechanical mounting features to fasten a modular series of grille plates or grille fins to the grille frame.

Described herein are various examples of an improved front grille assembly for a motor vehicle to enable easier removal, replacement, and/or cleaning of both grille screens and/or grille fins and grille plates. Specifically, using a front grille assembly constructing in accordance with the present disclosure may allow for quicker, more convenient removal, replacement, and/or cleaning of grille screens and/or grille fins and plates.

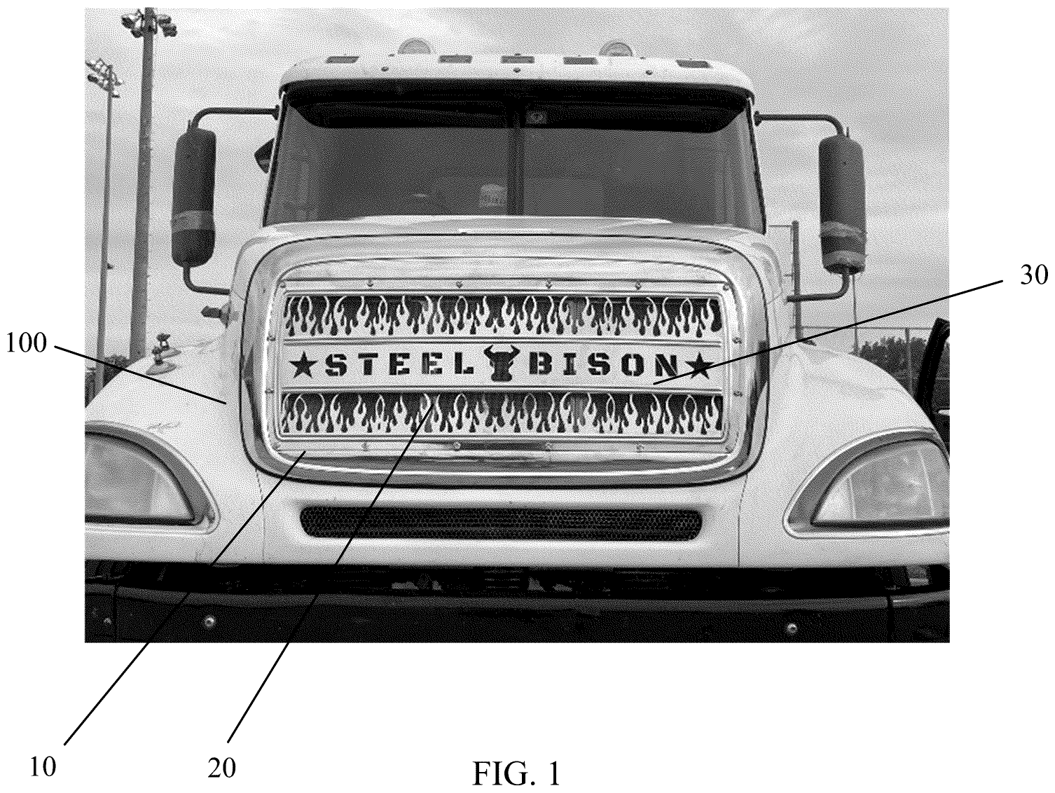

Referring now to the drawings wherein like reference numerals are used to identify identical components in the various views, in one example as shown from one perspective in FIG. 1, a front grille assembly 100 may be provided for installation on to a motor vehicle. The example front grille assembly includes a grille frame 10, a screen 20, and a grille plate 30. The grille frame 10 is mounted to the motor vehicle at the opening on the front hood of the motor vehicle. The screen 20 is mounted to the grille frame 10 at various mechanical mounting points as will be described. Meanwhile, the example grille plate 30 is mountable onto the grille frame 10 over the screen 20 and, in this instance, partially obscuring the view of the screen 20 to enhance the aesthetic appearance of the front grille assembly 100. It will be appreciated by one of ordinary skill in the art that in some examples, at least one of the grille plate 30 or the screen 20 may be eliminated and/or not used as desired. In addition, while the example grille plate 30 and the screen 20 are illustrated as separately mountable parts, it will be understood that the grille plate 30 and/or the screen 20 may be integrally formed with one another, may be permanently mounted to one another, and/or may be formed in various parts or sub assemblies as desired.

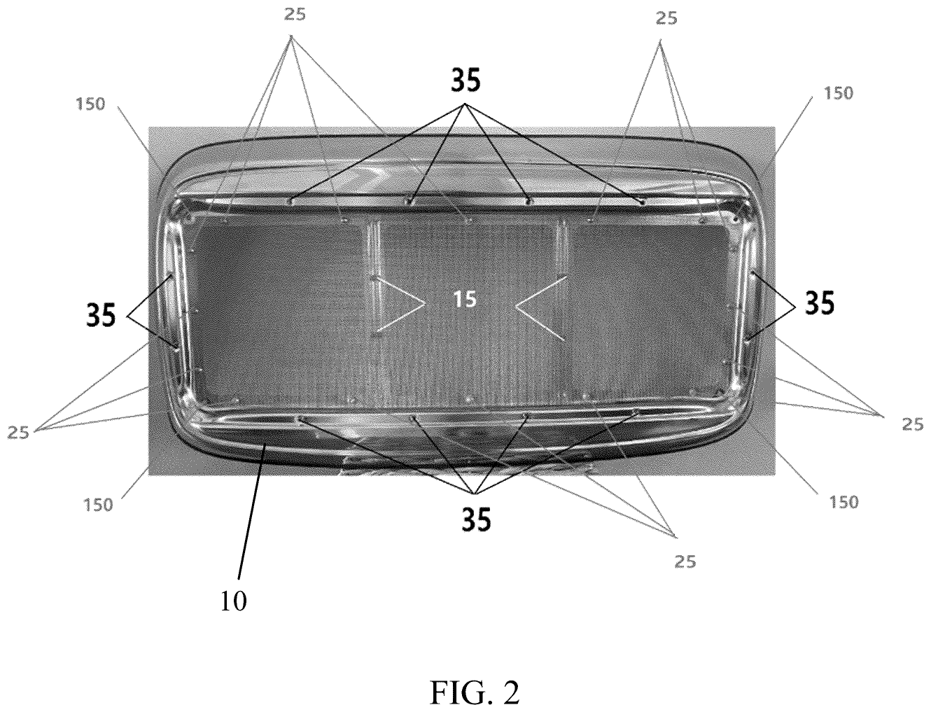

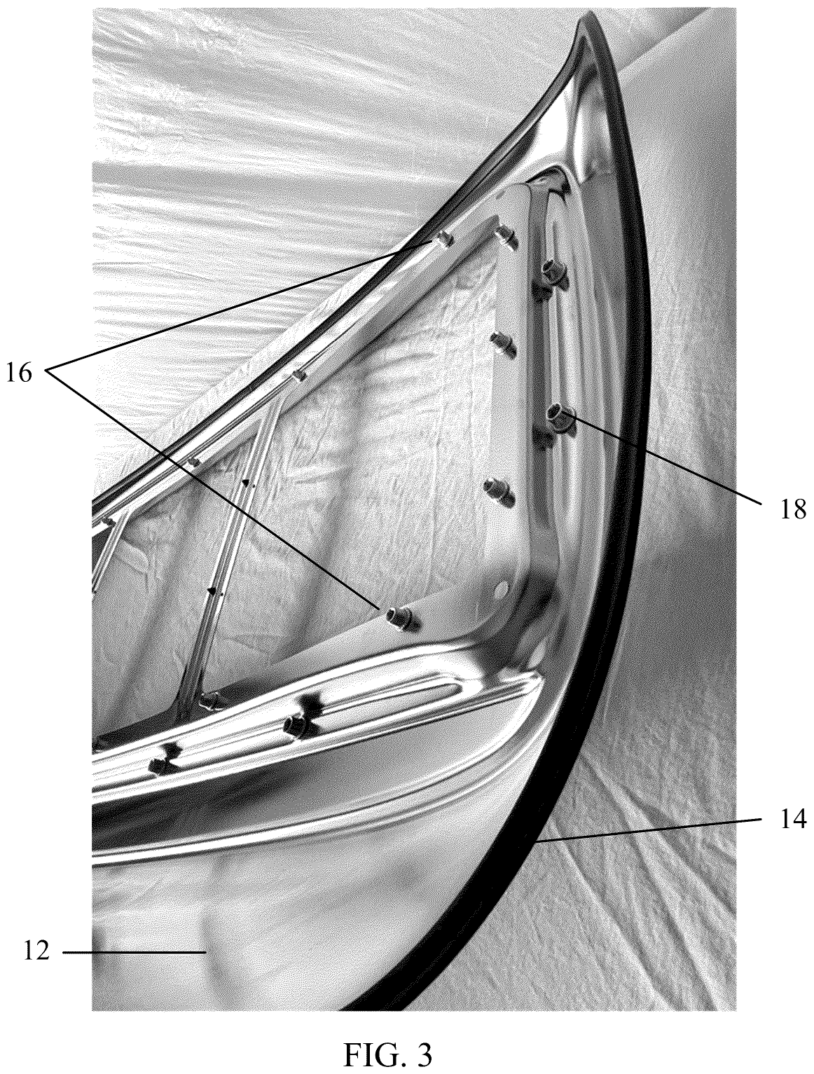

FIGS. 2 and 3 show a front perspective view of the example grille frame 10, and a rear perspective detail view of the same grille frame 10, respectively. As shown in FIG. 2, the grille frame 10 further contains a first pattern 150 of fastener features, a second pattern 25 of fastener features, and a third pattern 35 of fastener features. More precisely, in this example, the first pattern 150 of fastener features define various fastener apertures, as is best seen in FIG. 2, and which align with the mechanical mounting or corresponding fastener features of a hood on a motor vehicle (such as the truck shown in FIG. 1). The second pattern 25 of fastener features align with fastener features or apertures of the example screen 20 to be installed on the grille frame 10. In some examples, the screen installed on the second pattern 25 may be a screen other than the example screen 20, or other suitable grille attachment, such as a grate, filter, etc. The third pattern of fastener features 35, meanwhile, align with fastener features or apertures of the grille plate 30 to install the grille plate 30 onto the grille frame 10. Again, it will be understood that in some examples, the installed grille plate 30 may be any suitable grille plate other than the illustrated grille plate 30, or may be any suitable grille attachment as desired.

In this example, the grille frame 10 is made from a stainless steel. In other examples, the grille frame 10 may be made from any suitable material, such as for example, metal, composite, plastic, wood, or other similar materials and may be manufactured by stamping, machining, drawing, molding, extruding, or other similar manufacturing techniques, and still may achieve the same results by functioning in the same way.

As shown in FIG. 3, the example grille frame 10 includes a mounting surface 12. The geometry of the example mounting surface 12 is shaped to match the existing geometry of an opening of the hood on the motor vehicle (see FIG. 1). In this example, the mounting surface 12 has a damper 14 attached to it. The damper 14 contacts the hood of the motor vehicle and prevents or reduces vibration between the mounting surface 12 of the grille frame 10 and the hood of the motor vehicle when the motor vehicle is in operation by acting as a cushion. Reducing the vibration between the grille frame 10 and the hood of the motor vehicle may, among other things, prevent the components from wear and noise or chattering from the vibration. The damper 14 may also ensure a secure fit between the grille frame 10 and the hood of the motor vehicle. It will be appreciated that in some examples, the damper 14 may be modified to be smaller, larger, different shapes, or omitted entirely as desired.

The damper 14 may be made from a rubber, composite, plastic, wood, metal, or any other suitable materials and may be manufactured by injection molding, machining, forming, extruding, or any other similar or known manufacturing methods and function in much the same way while still achieving the same result. The damper 14 may be press fit, mechanically fastened, chemically adhered to, or tension fit onto the mounting surface 12 of the grille frame 10, or fastened by any other known methods, to achieve the same result by functioning in the same way.

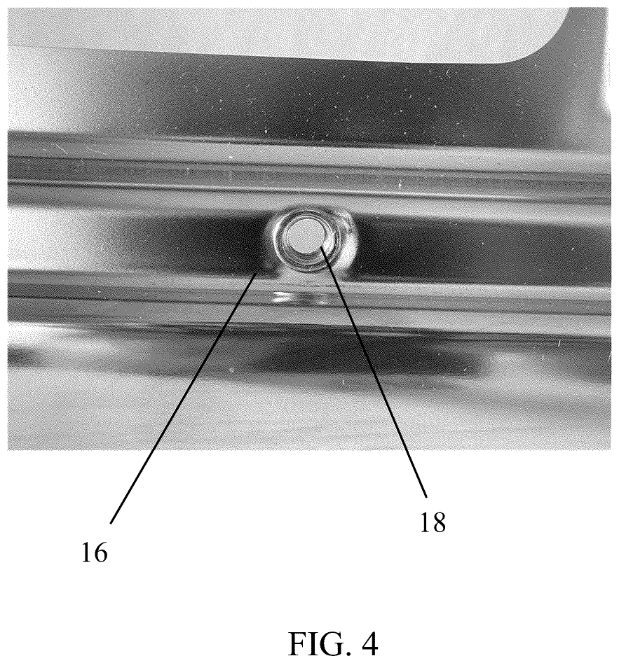

As shown in FIGS. 2-3, and in detail in FIG. 4, the example grille frame 10 includes fastener features 16, which are in various configurations or patterns on the grille frame 10. For instance, in this example the fastener features 16 are in the first pattern 150, the second pattern 25, and the third pattern 35 of fastener features previously noted. In some examples, the fastener features 16 may be a simple fastener aperture which allows a fastener to pass through the aperture and fasten to another component. In other examples, the fastener features 16 may be a threaded insert 18. In this example, the threaded insert 18 is attached to the grille frame 10 by mechanically pressing the threaded insert 18 onto the grille frame 10. In some embodiments, a rivet containing a threaded nut insert (i.e. a “riv-nut”) may be inserted through an aperture on the grille frame 10 and mechanically pressed or pinched together, securing the riv-nut 18 to the grille frame 10. In this manner, a fastener feature may be provided on the grille frame 10 into which a fastener may be inserted and tightened. The riv-nuts may be made from metal, plastic, wood, composite, or other like materials and manufactured by machining, casting, molding, or other similar methods to achieve the same result by functioning in the same way.

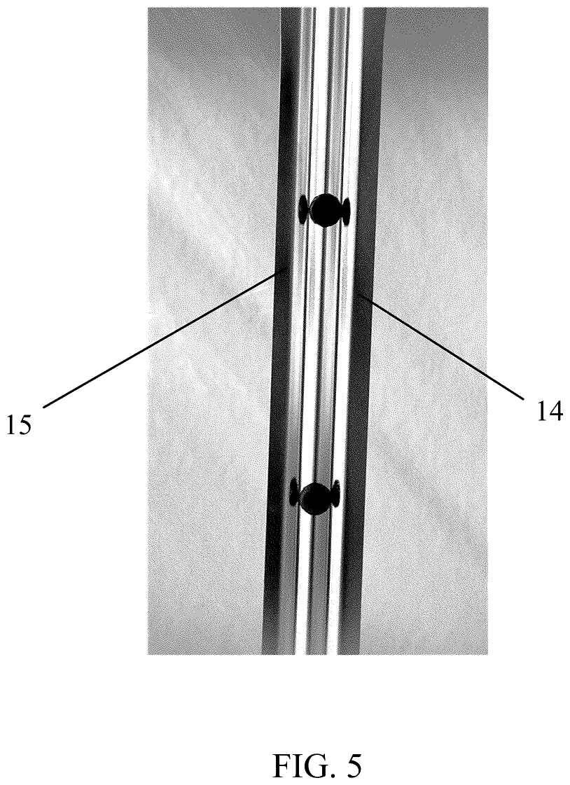

As shown in in FIG. 5, in this example the grille frame 10 includes a secondary damper 15. The secondary damper 15 provides support to, and reduces or eliminates vibration between the grille frame 10 and the screen 20, grille which is fastened to the grille frame 10. The secondary damper 15 may be made from a rubber, composite, plastic, wood, metal, or any other suitable materials and may be manufactured by injection molding, machining, forming, or any other similar or known manufacturing methods and function in much the same way while still achieving the same result. The secondary damper 15 may be press fit, mechanically fastened, chemically adhered to, or tension fit onto the grille frame 10, or fastened by any other known methods, to achieve the same result by functioning in the same way.

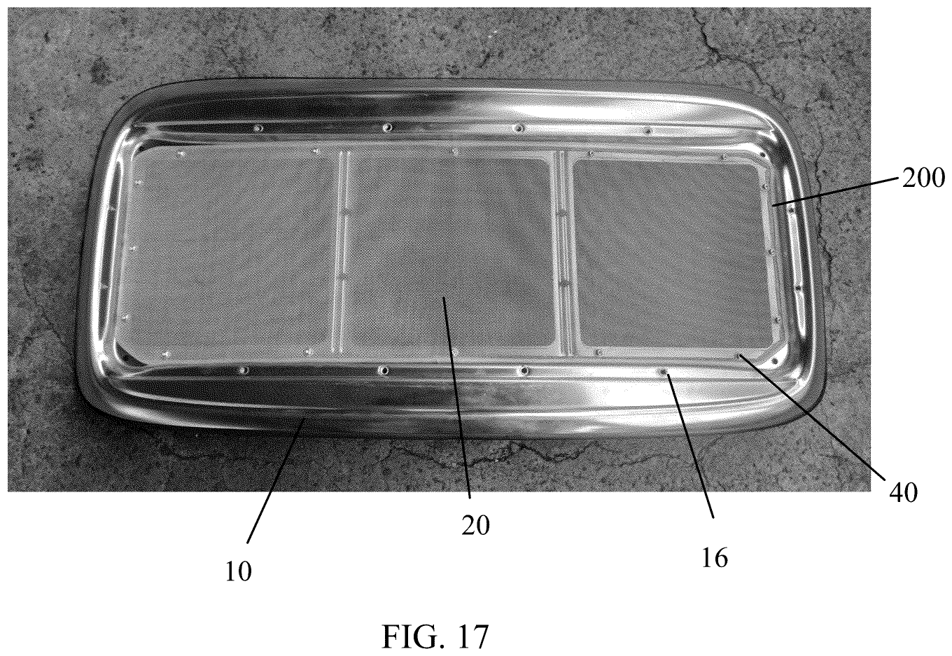

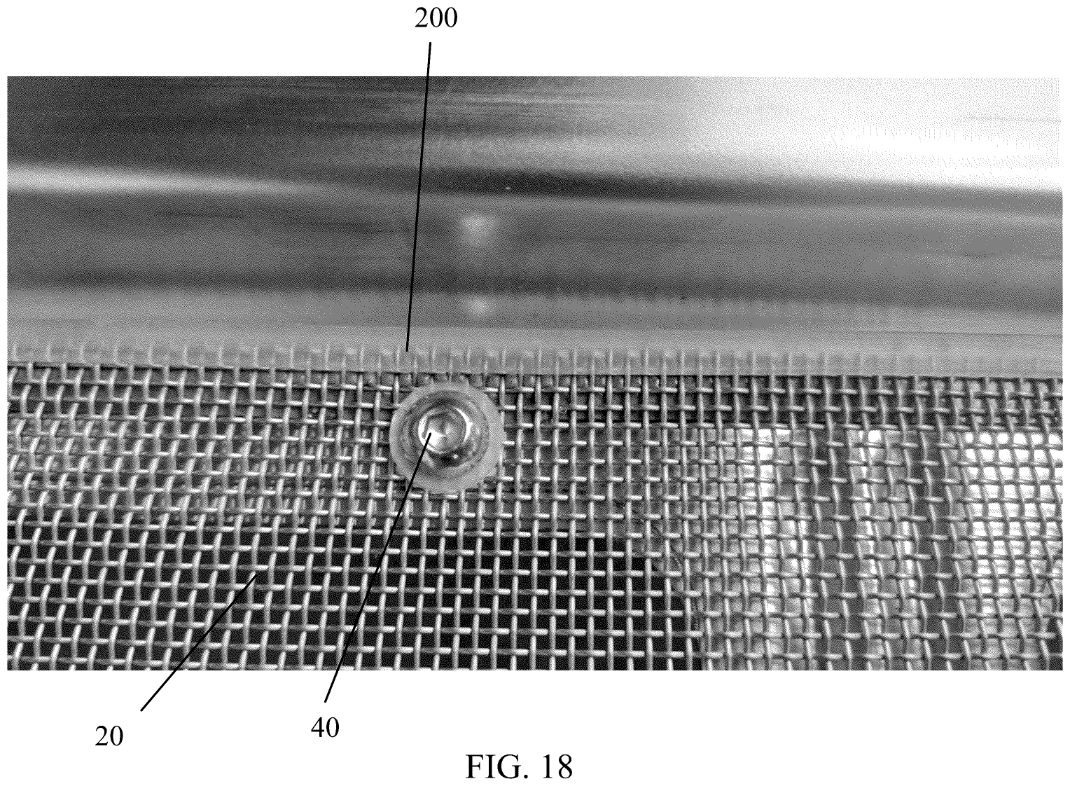

In some embodiments, the grille frame 10 includes a third damper 200 around the edge of the screen 20 to cover any sharp edges and to prevent any injuries that may occur while the screen 20 is being handled either during installation or cleaning, as seen in FIG. 17. The third damper 200 may be made from a rubber, composite, plastic, wood, metal, or any other suitable materials and may be manufactured by injection molding, machining, forming, or any other similar or known manufacturing methods and function in much the same way while still achieving the same result. The third damper 200 may be press fit, mechanically fastened, chemically adhered to, or tension fit onto the screen 20, or fastened by any other known methods, to achieve the same result by functioning in the same way. As seen in FIG. 18, in some embodiments, fasteners 40 also include a damper to reduce or eliminate vibration between the grille frame 10 and the screen 20 and to prevent any injuries that may occur while the screen 20 is being handled either during installation or cleaning.

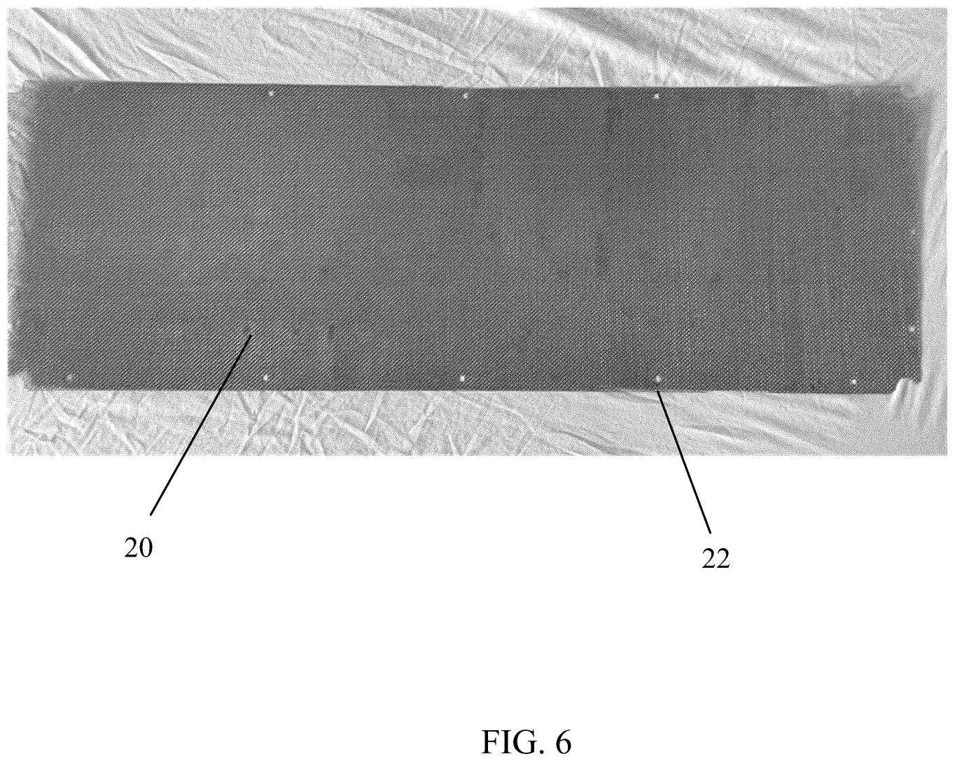

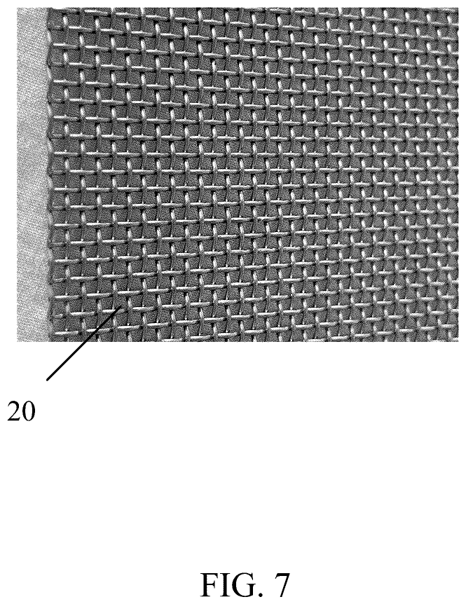

Shown in FIG. 6, and in greater detail in FIG. 7, the example screen 20 is also provided with the front grille assembly 100. As noted, the screen 20 may filter air entering through the front grille assembly 100 to remove bugs, small rocks, and other roadway debris and prevent the debris from entering the hood of the motor vehicle. The screen 20 may be made from metal, plastic, composite, wood, or other similar material and may be manufactured by machining, stamping, molding, extruding, or other similar manufacturing techniques to achieve the same result by functioning in the same way. In the example embodiment shown, the screen 20 is comprised of many wires which are woven together to form a mesh. The spacing of the mesh may allow air to pass through the screen 20 and different spacings of the mesh may allow different flow rates of air, which may regulate the cooling of the components of the motor vehicle at different rates.

As shown, the screen 20 includes fastener apertures 22 cut from the screen 20. The example fastener apertures 22 allow for mechanical fasteners to pass through the screen 20 and secure the screen 20 to the grille frame 10. In this example, the fastener apertures 22 are arranged in the second pattern 25 which align with a pattern of fastener features on the grille frame 10.

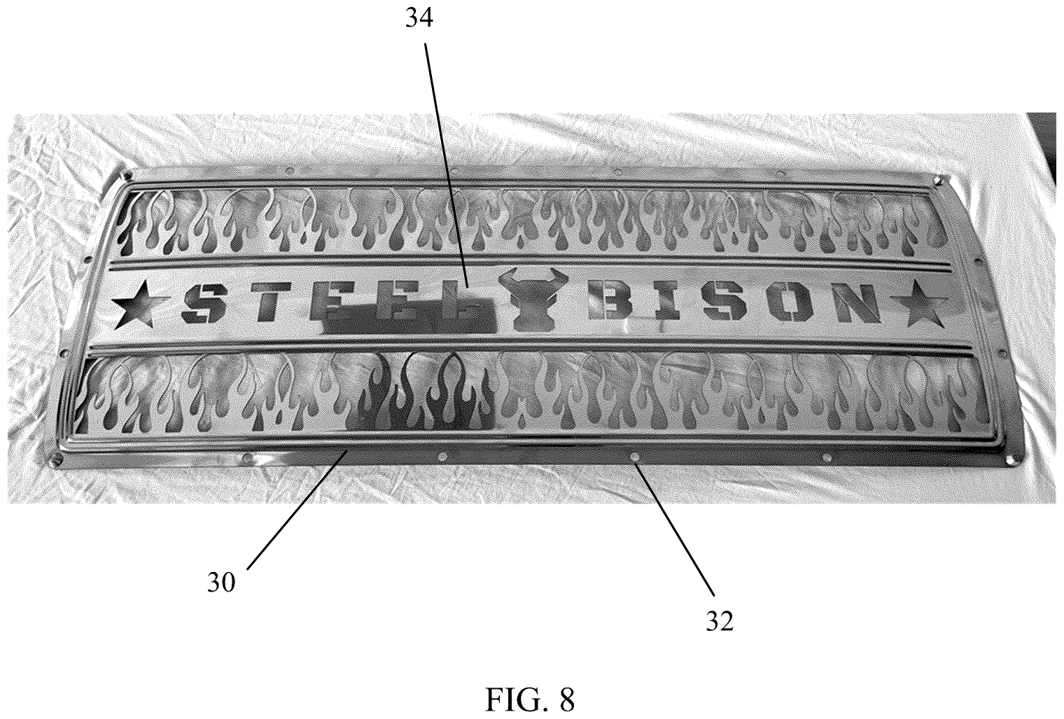

Turning now to FIG. 8, in this example, the front grille assembly 100 comprises the grille plate 30. As illustrated, the example grille plate 30 includes an aesthetic design 34 and the aesthetic design 34 may have a design to improve the aerodynamics of the front grille assembly 100. The grille plate 30 also includes fastener apertures 32 located in the third pattern 35 on the grille plate 30 which align with a pattern of fastener features on the grille frame 10. As will be appreciated, the grille plate 30 may be made from metal, plastic, wood, composite, stainless steel, or other similar material and may be manufactured by stamping, forming, extruding, molding, machining, or other similar manufacturing techniques to achieve the same result by functioning in the same way.

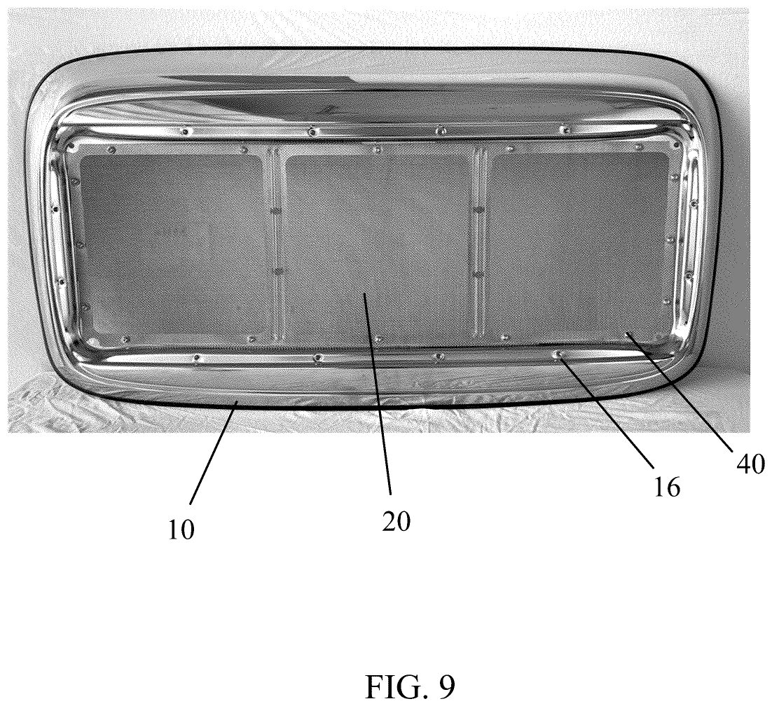

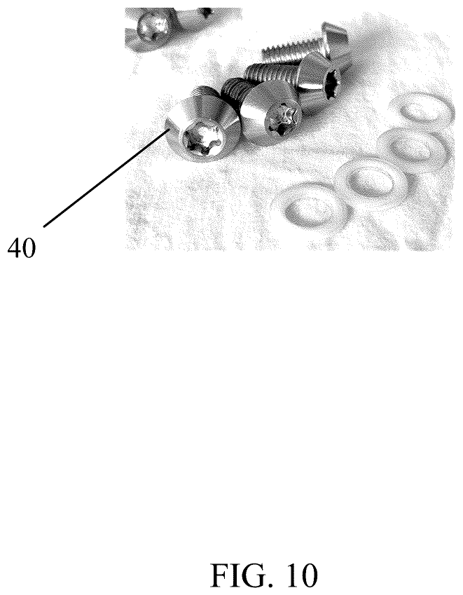

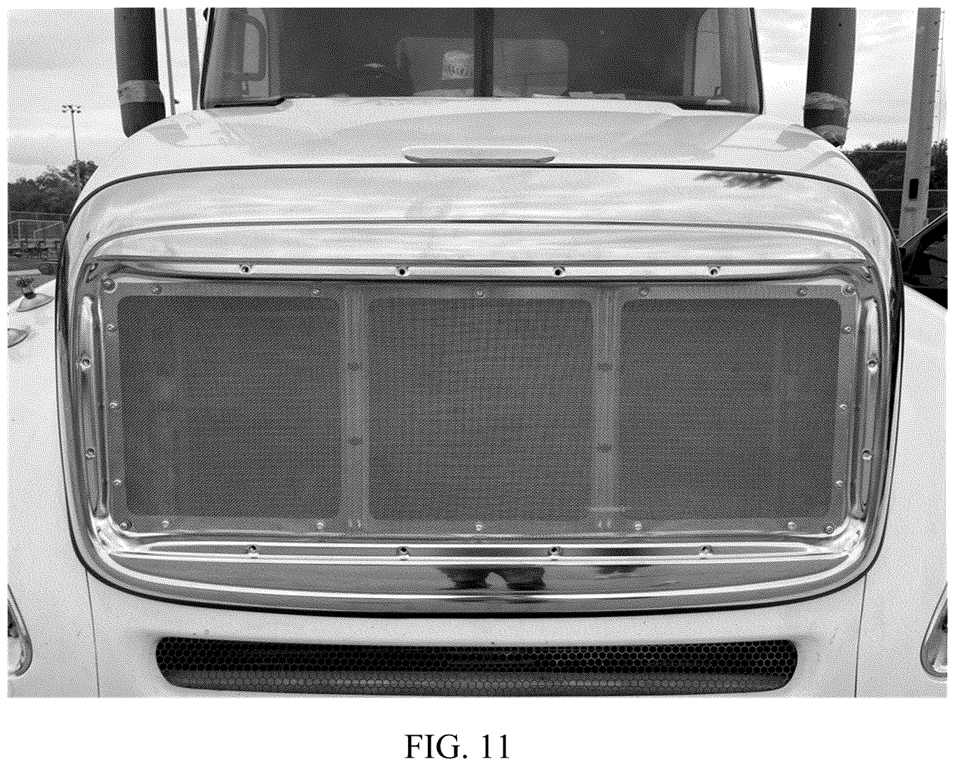

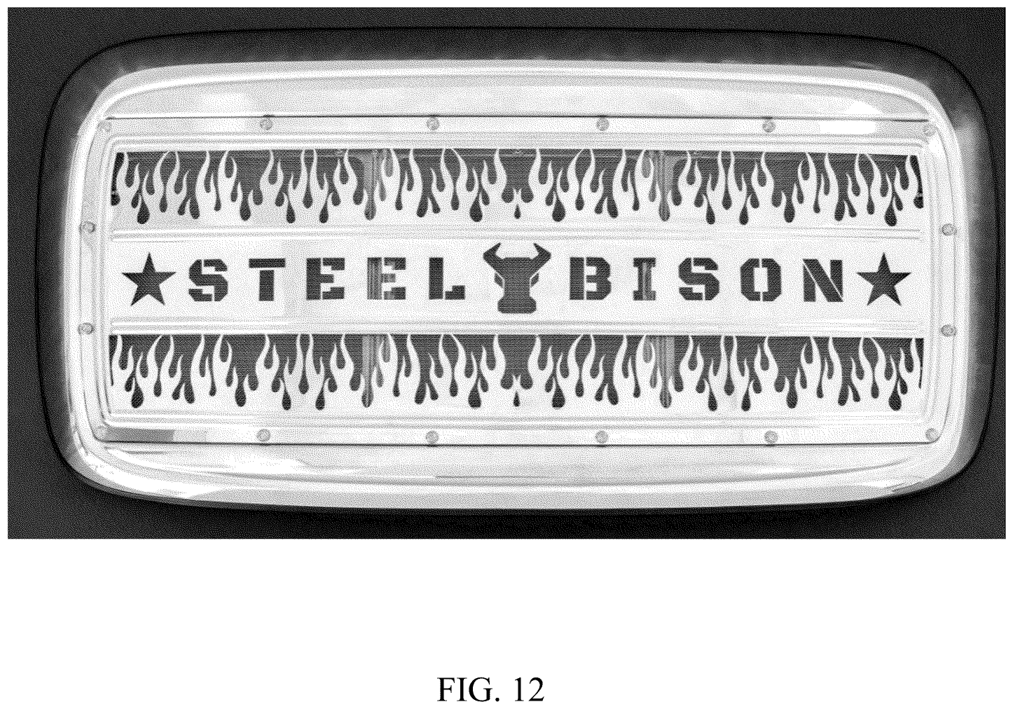

Referring now to FIGS. 9-12, the example front grille assembly 100 is illustrated as installed on a motor vehicle, for instance, a truck. The front grille assembly 100 comprising the grille frame 10, the screen 20, the grille plate 30, and the plurality of fasteners 40 as detailed above. The grille frame 10 is mounted to the motor vehicle by aligning the first pattern 150 of fastener features, which in the example embodiment are fastener apertures 16, to the motor vehicle's hood. The fasteners 40 are then inserted through the fastener apertures 16 on the grille frame 10 and secured to fastener features located on the hood of the motor vehicle. The screen 20 is installed on the grille frame 10 by aligning the fastener apertures 22 on the screen 20 (see FIG. 6) with the second pattern of fastener features 25 on the grille frame 10, which in the example embodiment are threaded inserts 18. The fasteners 40 are then inserted through the fastener apertures 22 on the screen 20 and into the threaded inserts 18 on the grille frame 10, which in the example embodiment are the threaded inserts of riv-nuts.

The grille plate 30 is then installed over the screen 20 onto the grille frame 10 by aligning the fastener apertures 32 on the grille plate 30 (see FIG. 8) with the third pattern 35 of fastener features on the grille frame 10. the fasteners 40 are then inserted through the fastener apertures 32 on the grille plate 30 and into the fastener features 16 on the grille frame 10, which in the example embodiment are the threaded inserts of riv-nuts 18. In this way, the front grille assembly 100 is installed onto the motor vehicle and the grille plate 30 may be removed without opening or otherwise accessing the interior of the hood of the motor vehicle, and the screen 20 may be removed without opening or otherwise accessing the interior of the hood of the motor vehicle, and the screen may be replaced without the need for additional replacement components, such as clips, to retain the screen in place.

In the example embodiment, to remove the grille plate 30, a user would remove the fasteners 40 securing the grille plate 30 to the grille frame 10. The user does not need to open the hood of the motor vehicle or otherwise access any interior surface of the motor vehicle. The user can then clean the grille plate 30 or swap the grille plate 30 for a grille plate with another aesthetic design 34. The user may change the aesthetic design 34 for functional (i.e. aerodynamic, by changing geometry of fins) or aesthetic (i.e. choosing a new design or pattern) reasons without having to access the interior surfaces of the hood or motor vehicle.

In the example embodiment, to remove and replace or remove and clean the screen 20 the user would first remove the grille plate 30 according to the manner described above. Then, the user would remove the fasteners 40 which secure the screen 20 to the grille frame 10. In this manner, the user does not need to open the hood or otherwise access any interior surface of the motor vehicle to remove and replace the screen 20. The user may then clean the screen 20 and replace it or replace the screen 20 with a different screen containing a different spacing of mesh, which would allow for a different air flow to the internal components and produce a different rate of cooling to the components. To replace the screen 20 or install a new screen, the user may use the fasteners 40 to resecure the screen 20 to the grille grille frame 10 in the same manner as when the user first installed the screen 20. The user is thus able to replace the screen 20 without the need for additional replacement components such as clips which may break, deform, or otherwise need replacement when replacing the screen 20.

Although the example embodiment disclosed above may use riv-nuts and threaded fasteners, it will be readily understood that any means of mechanical or chemical fastening may be utilized to accomplish the same result by functioning in the same way. For example, hook and loop tape may be used, regular tape, magnetic fasteners may be used, ties, tie wire, rivets, spring clamps, and other mechanical fastening and chemical fastening methods may be used to accomplish the same result by functioning in the same way. The fastening methods may all allow for the grille plate and the screen to be removed without needing to access the internal surface, or the inside of the hood of the motor vehicle.

Example methods and systems are described above. It should be understood that the words “example” and “exemplary” are used therein to mean “serving as an example, instance, or illustration.” Any embodiment or feature described therein as being an “example” or “exemplary” is not necessarily to be construed as preferred or advantageous over other embodiments or features. In the above detailed description, reference is made to the accompanying figures, which form a part thereof. In the figures, similar symbols typically identify similar components, unless context dictates otherwise. Other embodiments may be utilized, and other changed may be made, without departing from the spirit or scope of the subject matter presented herein.

The example embodiments described above are not meant to be limiting. It will be readily understood that the aspects of the present disclosure, as generally described therein, and illustrated figures, can be arranged, substituted, combined, separated, and designed in a wide variety of different configurations, all of which are explicitly contemplated herein.

The systems and methods described herein offer multiple benefits to front grille assemblies for motor vehicles. While various aspects and embodiments have been disclosed herein, some aspects and embodiments will be apparent to those skilled in the art. The various aspects and embodiments disclosed herein are for purposes of illustration and are not intended to be limiting, with the true scope and spirit being indicated by the following claims. Some embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. An apparatus for a front grille assembly for a motor vehicle, comprising:
a grille frame mountable to a vehicle hood of the motor vehicle, the grille frame comprising a first pattern of fastener features for attachment to the vehicle hood, a second pattern of fastener features for securing a screen, and a third pattern of fastener features for securing a grille plate;
the screen removably mountable to the grille frame via the second pattern of fastener features, the screen configured to filter debris while allowing airflow into the vehicle hood;
the grille plate removably mountable to the grille frame via the third pattern of fastener features, the grille plate providing aesthetic and aerodynamic features; and
a plurality of dampers positioned between the grille frame and the vehicle hood, and between the grille frame and the screen, to reduce vibration and ensure a secure fit,
wherein the grille frame, the screen, and the grille plate are configured to be removed and replaced without accessing an interior of the vehicle hood.

2. The apparatus of claim 1, wherein the grille frame is made from stainless steel.

3. The apparatus of claim 1, wherein the screen comprises a woven mesh of wires, allowing for different airflow rates based on a mesh spacing.

4. The apparatus of claim 1, wherein the grille plate includes an aesthetic design that enhances an aerodynamic property of the front grille assembly.

5. The apparatus of claim 1, wherein the plurality of dampers are made from rubber and are configured to be press fit onto the grille frame.

6. The apparatus of claim 1, wherein the fastener features include threaded inserts for securing the screen and the grille plate to the grille frame.

7. The apparatus of claim 1, wherein the grille frame is configured to match a geometry of the vehicle hood.

8. The apparatus of claim 1, wherein the screen is configured to be replaced with a different screen having a different mesh spacing to alter airflow and cooling rates.

9. The apparatus of claim 1, wherein the grille plate is configured to be swapped with a different grille plate having a different aesthetic design.

10. The apparatus of claim 1, wherein the plurality of dampers are configured to reduce noise and wear caused by a vibration during vehicle operation.

11. A method for installing a front grille assembly on a motor vehicle, comprising:
providing a grille frame configured with a first pattern of fastener features for attachment to a vehicle hood, a second pattern of fastener features for securing a screen, and a third pattern of fastener features for securing a grille plate;
mounting the grille frame to the vehicle hood by aligning the first pattern of fastener features with corresponding fastener features on the vehicle hood;
attaching the screen to the grille frame by aligning the screen with the second pattern of fastener features, the screen configured to filter debris while allowing airflow into the vehicle hood;
securing the grille plate to the grille frame by aligning the grille plate with the third pattern of fastener features, the grille plate providing aesthetic and aerodynamic features;
positioning a plurality of dampers between the grille frame and the vehicle hood, and between the grille frame and the screen, to reduce a vibration and provide a secure fit;
enabling a removal and a replacement of the grille frame, the screen, and the grille plate without accessing an interior of the vehicle hood.

12. The method of claim 11, further comprising the step of selecting the grille frame from a material group consisting of stainless steel, composite, and plastic.

13. The method of claim 11, wherein the step of attaching the screen includes selecting a screen with a specific mesh spacing to regulate airflow and cooling rates.

14. The method of claim 11, further comprising the step of selecting the grille plate with an aesthetic design that enhances an aerodynamic property of the motor vehicle.

15. The method of claim 11, wherein the step of positioning the plurality of dampers includes selecting dampers made from rubber to reduce noise and wear caused by a vibration.

16. The method of claim 11, further comprising the step of using threaded inserts as the fastener features for securing the screen and the grille plate to the grille frame.

17. The method of claim 11, wherein the step of enabling the removal and the replacement includes using quick-release fasteners to facilitate easy disassembly and reassembly.

18. The method of claim 11, further comprising the step of aligning the grille frame with a geometry of the vehicle hood to provide a seamless fit.

19. The method of claim 11, wherein the step of securing the grille plate includes an option to interchange the grille plate with another grille plate having a different design without requiring additional tools.

20. The method of claim 11, further comprising the step of testing the installed grille assembly for a vibration reduction and the secure fit during vehicle operation.
